(19) United States
(12) Patent Application Publication
(10) Pub. No.: US 2017/0274384 A1
(43) Pub. Date: Sep. 28, 2017

(54) DRIVE ASSEMBLY FOR A ROLL CRUSHER

(71) Applicant: Siemens Aktiengesellschaft, 80333 München (DE)

(72) Inventors: DIETMAR POHLING, Dresden (DE); RONALD FENNIS, AS Winterswijk (NL)

(73) Assignee: Siemens Aktiengesellschaft, 80333 München (DE)

(21) Appl. No.: 15/501,637

(22) PCT Filed: Jul. 30, 2015
(86) PCT No.: PCT/EP2015/067452

§ 371 Date: Feb. 3, 2017

(30) Foreign Application Priority Data
Aug. 5, 2014 (EP) 14179796.9

(51) Int. Cl. B02C 4/42; B02C 4/30; B02C 4/08

(52) U.S. Cl. CPC B02C 4/42; B02C 4/08; B02C 4/30; B02C 4/10

(57) ABSTRACT

A drive arrangement for a roll crusher includes two rollers arranged in parallel, two trains, each for driving a roller. The two drive trains each has a gear transmission including a drive shaft which can connect to a motor and an output shaft which can connect with a roller. Each gear transmission includes an intermediate shaft arranged between the drive shaft and the output shaft. The intermediate shafts are connected to each other via a slip-free torque transmission device which allows an offset of the gear transmissions in relation to each other in combination with a torque limiting clutch which terminates the connection for a conjoint rotation of the intermediate shafts when an adjustable torque is exceeded.

The present invention relates to a drive assembly for a roll crusher.

Roll crushers are known for the comminution of lumpy material, for example stone or coal, generally using two counter-rotating toothed rollers, between which the material to be broken up is fed. Synchronized rotation of the rollers effects the comminution process by the constant repetition of converging movements of the toothed rollers thus enabling a defined degree of comminution to be achieved. The efficiency of the comminution process is also dependent upon the synchronized rotation of the rollers.

CN 201200902 Y (Guizhou Lailisi Machinery Design and Manufacturing Co., Ltd.) 2009 Mar. 4 describes a roll crusher comprising two rollers 13 and two independent drives, each comprising a motor 1, a fluid coupling 2 and a gear 3. A common synchronizing gear 10 is arranged between the two gears 3 and the rollers 13 in order to synchronize the rotation of the two rollers.

EP 1 593 435 A1 (Bondioli, Edi) Sep. 11, 2005, which is considered to be the closest prior art, discloses a drive assembly as claimed in the preamble to claim 1.

When starting up a roll crusher, it is necessary in many cases to effect a, sometimes repeated, change to the angular position of the rollers in relation to each other until the granularity of the material to be crushed corresponds to requirements. It may also be necessary to readjust the angular position in the event of a change in the properties of the comminuted material.

It is the object of the present invention to simplify the adjustment of the angular position of the rollers of a roll crusher.

This object is achieved according to the invention by a drive assembly for a roll crusher with the features disclosed in claim 1. This object is also achieved according to the invention by a method with the features disclosed in claim 7.

The drive assembly is suitable for a roll crusher comprising two rollers arranged in parallel, which are also known as crusher shafts. The drive assembly comprises two drive trains each for driving a roller. The drive trains each have a gear transmission comprising a drive shaft which can be connected to a motor and an output shaft which can be connected to a roller. Each gear transmission comprises an intermediate shaft arranged between the drive shaft and the output shaft. The intermediate shafts of the gear transmissions are connected to each other by a slip-free torque transmission device, which allows an offset of the gear transmissions in relation to each other, in combination with an overload clutch, which terminates the connection for conjoint rotation of the intermediate shafts when an adjustable torque is exceeded.

The method is used for synchronizing the roller rotation of a roll crusher comprising two rollers arranged in parallel and a drive assembly according to the invention, as described above. In this context, the method has the following steps: releasing the connection for conjoint rotation of the intermediate shafts; rotation of at least one of the intermediate shafts until a defined angular position of the rollers is achieved; and restoration of the connection for conjoint rotation of the intermediate shafts.

The gear transmissions, which, unlike like V-belt transmissions or friction gearing, enable slip-free transmission, translate the speed of the drive shafts that can be driven by motors (fast transmission side) into a lower speed of the output shafts (slow transmission side). The invention is now based on the concept of providing the adjustment of the angular position, i.e. the synchronization, of the rollers on the fast-rotating, easily accessible side of the transmission and not on the slowly rotating transmission side, as is the practice in the prior art. Roll crushers with rollers that are synchronized on the slowly rotating transmission side are also referred to as slow-running synchronized roll crushers.

A subsequent adjustment of the angular position of the crusher shafts in relation to each other is only possible on a slow-running synchronized roll crusher with a great deal of effort. In this case, the high degree of effort is due to the very heavy gear wheels with which the synchronization takes place directly on the crusher shafts. In order to change the angular position of the crusher shafts in relation to each other, it is necessary for at least one gear wheel to be dismantled using crane technology and special tools and re-assembled following the correction of the angular position.

As a result of the synchronization of the two drives and hence the two crusher shafts in the fast-running, easily accessible transmission range via two synchronizing bevel gears, very little effort is required for the subsequent fine adjustment of the angular position of the crusher shafts in relation to each other. The present invention enables the angular position of the crusher shafts in relation to each other to be adjusted subsequently without cumbersome dismantling of the crusher and hence achieves a significant improvement in the crushing efficiency.

It is also possible for the adjustment of the angular position of the rollers on the fast-running transmission side to be performed much more accurately than on the slow-running transmission side: due to the ratio of the gear transmission, one revolution of the intermediate shaft only corresponds to a fraction of a revolution of a roller (depending upon the ratio, only a few angular degrees).

The uncomplicated subsequent and precise adjustability of the angular position of the two crusher shafts in relation to each other enables the crushing efficiency to be adapted and optimized with respect to the material to be crushed.

The invention supplements two existing drive trains of a roll crusher with a synchronizing train coupled to the two drive trains for conjoint rotation comprising a slip-free torque transmission device and an overload clutch.

An overload clutch, preferably a definably adjustable overload clutch, for example in the form of a slip clutch, prevents an unilateral transmission overload, i.e. the overloading of a transmission gear, which can result from undefined torque transmission from a first drive to the other drive. Hence, it is possible to calculate the maximum additional loading for an individual gear transmission caused by the synchronization. Hence, the overload clutch serves as a safety clutch in order to prevent undefined load conditions which could result in damage to the roll crusher.

Roll crushers, i.e. crushers comprising two rotating rollers, are used for the comminution of preferably mineral material to be crushed, such as stone, coal or oil sand. Crushing or cutting teeth can be arranged on the circumference of the crushing rollers. The rotary axes of the crushing rollers lie substantially parallel in relation to each other and are, as a rule, horizontal or approximately horizontal. Preferably, directly adjacent crushing rollers have opposite directions of rotation.

Advantageous embodiments and developments of the invention are disclosed in the depended claims. At the same time, the method according to the invention can also be developed in accordance with the dependent device claims and vice versa.

According to one preferred embodiment of the invention, the torque transmission device comprises two synchronizing bevel gears each with an input shaft and each with an output shaft. In this context, the input shafts are each connected to the intermediate shafts for conjoint rotation. The output shafts are connected to each other by means of a shaft connection allowing an offset of the output shafts. The shaft connection allowing an offset of the output shafts can, for example, comprise an articulated shaft and/or a compensating clutch. An articulated shaft is a shaft, which is divided by one or more joints into in two or more shaft sections. In this way, the joints enable a radial, angular or even axial offset of the shaft sections. A compensating clutch is a clutch able to compensate an axial and/or radial and/or angular shaft displacement. Suitable compensating clutches are, for example, a double-tooth clutch or a spring-plate clutch.

According to one preferred embodiment of the invention, the torque transmission device comprises a chain or a toothed belt by means of which the intermediate shafts are connected to each other. Chains and toothed belts represent a slip-free torque transmission device that allows an offset of the driving shaft and the driven shaft in relation to each other. In this case, the driving shaft and the driven shaft are parallel to each other. In this case, the overload clutch can, for example, be arranged between a chain pinion or a toothed belt pulley and the corresponding bearing shaft.

According to one preferred embodiment of the invention, in each case gear wheels are arranged on the drive shaft and the intermediate shaft wherein said gear wheels mesh directly with each other. Therefore, the intermediate shafts, which are synchronized with each other by the connection for conjoint rotation, are shafts, which—viewed in the direction of the torque transmission—are arranged in the gear transmission directly after the drive shaft. Since the drive shaft of the gear transmission rotates at the speed of the drive motor, the directly downstream intermediate shafts are also relatively fast-rotating shafts.

According to one preferred embodiment of the invention, the gear transmissions each comprise one or more drive train spur gear stages and/or drive train bevel gear stages and/or drive train planetary gear stages. The multiple teeth meshing of one planetary stage enables this to transmit a high torque in little space. Hence, the greatest possible torque can be transmitted to each crushing roller with a prespecified crushing roller spacing.

The invention is described in the following with reference to several exemplary embodiments and the attached drawing. The figures, which are in each case schematic and not true to scale, show in:

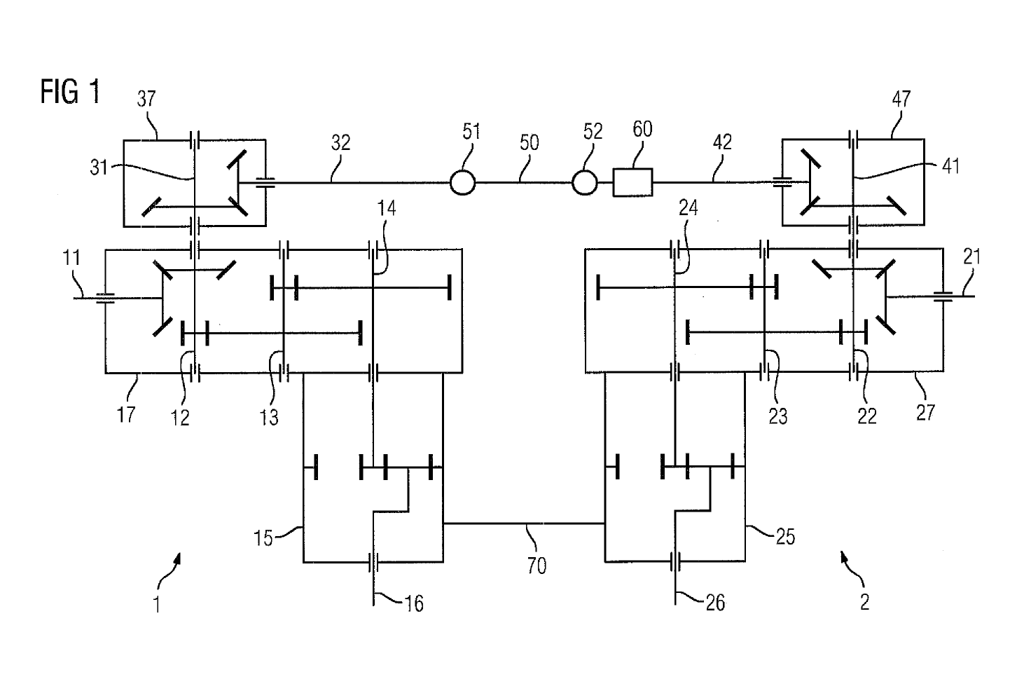

FIG. 1 a transmission scheme of a drive assembly according to the invention;

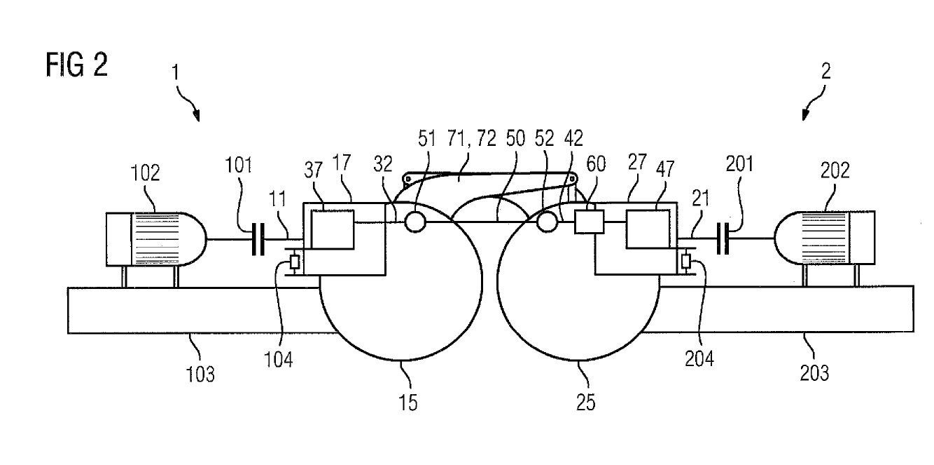

FIG. 2 a side view of a roll crusher with a drive assembly according to the invention;

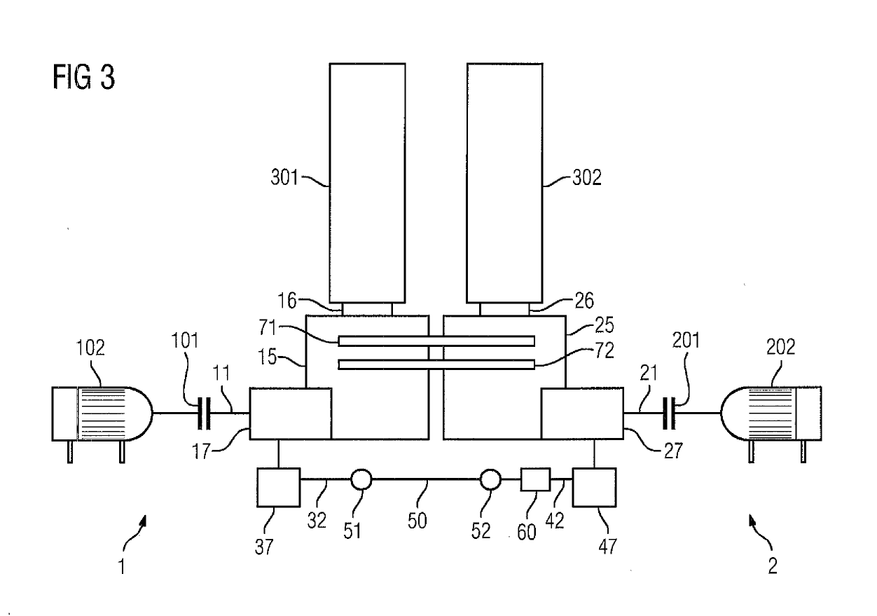

FIG. 3 a top view of the roll crusher shown in FIG. 2;

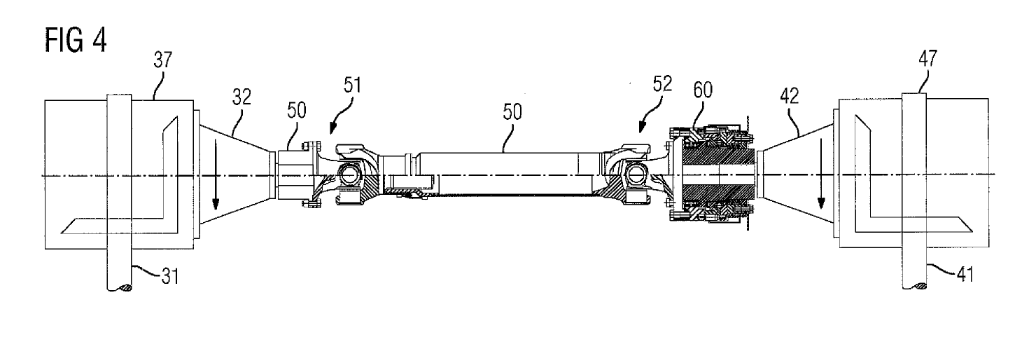

FIG. 4 a detail view of an articulated shaft and an overload clutch; and

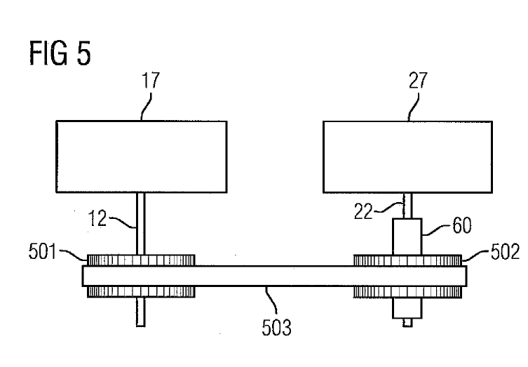

FIG. 5 a top view of shaft synchronization by means of a chain transmission or a synchronous belt.

FIG. 1 shows a transmission scheme of a drive assembly according to the invention with a first drive train 1 and a second drive train 2. The first and the second drive train 1, 2 are mirror images of each other. The two drive trains 1, 2 give rise to inversely oriented torques which are mutually supported by a supporting element 70. Each of the two drive trains 1, 2 comprises a drive train bevel gear 17, 27 with a downstream planetary gear 15, 25. The drive train bevel gears 17, 27 each have a drive shaft 11, 21 that can be connected to a motor for conjoint rotation, for example an electric or hydraulic motor. A second gear wheel arranged on a first intermediate shaft 12, 22 meshes with a first gear wheel arranged on the drive shaft 11, 21. Instead of the bevel gear stage of the drive shaft 11, 21 shown in FIG. 1, it is also possible for a spur gear stage to be present. The rotation is transmitted via further intermediate shafts, in the present case a second and a third intermediate shaft 13, 14 or 23, 24, into a planetary gear 15, 25 comprising a sun wheel, a hollow wheel and at least one planetary wheel that meshes with the sun wheel and the hollow wheel mounted in a rotatable planetary wheel support, which in each case comprises an output shaft 16, 26. In the present exemplary embodiment, the output shafts 16, 26 are formed by the planetary wheel supports of the planetary gear 15, 25. The output shafts 16, 26 can be connected to the crusher rollers of the roll crusher for conjoint rotation.

The first intermediate shafts 12, 22 are each connected to the input shafts 31, 41 of synchronizing bevel gears 37, 47 for conjoint rotation. The two output shafts 32, 42 of the synchronizing bevel gears 37, 47 are connected to each other for conjoint rotation via an articulated shaft 50 comprising two joints 51, 52 and an overload clutch 60.

The coupling of the first intermediate shafts 12, 22 of the gear transmission by means of the synchronizing bevel gears 37, 47 and the articulated shaft 50 causes the two drive trains to have the same speed.

FIG. 2 is a side view of a roll crusher with a drive assembly according to the invention. The drive assembly comprises two drive trains 1, 2 giving rise to counter rotations of the rollers of the roll crusher. The first drive train 1 comprises a bevel gear 17 and a downstream single-stage planetary gear 15. The drive shaft 11 of the first drive train 1 is coupled via a coupling 101 to a drive motor 102 arranged on a motor swing base 103. The second drive train 2 has a similar design: this also has a bevel gear 27 and a downstream single-stage planetary gear 25. The drive shaft 21 of the second drive train 2 is coupled via a coupling 201 to a drive motor 202 arranged on a motor swing base 203. In each case, a first intermediate shaft of the bevel gears 17, 27 is connected to an input shaft of synchronizing bevel gears 37, 47. For torque support, in each case, a torque arm 104, 204 is arranged between the bevel gears 17, 27 of the drive train and the synchronizing bevel gears 37, 47. The two output shafts 32, 42 of the synchronizing bevel gears 37, 47 are connected to each other for conjoint rotation by an articulated shaft 50 comprising two joints 51, 52 and an overload clutch 60.

For torque support, in each case a torque arm 71, 72 is arranged between the planetary gears 15, 25.

FIG. 3 is a top view of the roll crusher shown in FIG. 2. In this case, the two torque arms 71, 72 between the planetary gears 15, 25 and the rollers 301, 302 of the roll crusher that are each connected to an output shaft 16, 26 of one of the two drive trains 1, 2 are clearly identifiable.

FIG. 4 is a detail view of an articulated shaft 50 and an overload clutch 60 connecting the output shafts of a first 37 and a second 47 synchronizing bevel gear to each other for conjoint rotation. The two joints 51, 52 of the articulated shaft 50 enable an offset that occurs during the operation of the roll crusher—radial and/or angular, to a certain degree also axial offset—of the output shafts 32, 42 of the synchronizing bevel gears 37, 47 to be compensated.

The overload clutch 60 is set such that it transmits the torque required for the synchronization of the two drive trains and is only released, for example by slipping, in the case of excessive torque, which could cause damage to the transmission.

FIG. 5 is a top view of shaft synchronization by means of a chain transmission or a synchronous belt. Each drive train for driving one of the two rollers of a roll crusher comprises a drive train bevel gear 17, 27. Mutually corresponding intermediate shafts 12, 22 of the drive train bevel gears 17, 27 extend beyond the transmission housing and each support a first and a second chain wheel 501, 502. In this case, the two chain wheels 501, 502 are connected to each other for conjoint rotation by means of a chain 503. In this case, the overload clutch 60 sits on one of the two intermediate shafts 12, 22, here: on the second intermediate shaft 22, and supports the second chain wheel 502. In this way, in the event of an overload, the second chain wheel 502 can slip on the second intermediate shaft 22. Unlike synchronization by means of bevel gears described in FIG. 1, the chain transmission synchronization dispenses with the diversion of the torque by 90 degrees by means of bevel gears; instead, the synchronization takes place immediately above the axially-parallel intermediate shafts 12, 22.

Instead of a chain gear, a similar synchronization of the two intermediate shafts 12, 22 can also take with place a synchronous belt, i.e. toothed belt pulleys and a toothed belt. In this optional embodiment, the reference numbers 501, 502 correspond to the toothed belt pulley and the reference number 503 to the toothed belt.

1-7. (canceled)

8. A drive assembly for a roll crusher, comprising:
two rollers arranged in parallel;
two drive trains configured to drive the rollers in one-to-one correspondence, each said drive train including a gear transmission which comprises a drive shaft configured for connection to a motor, an output shaft configured for connection to a corresponding one of the rollers, and an intermediate shaft arranged between the drive shaft and the output shaft;
slip-free torque transmission devices configured to allow an offset of the gear transmissions relative to each other; and
an overload clutch,
said intermediate shaft of one of the drive trains and said intermediate shaft of the other one of the drive trains being connected to each other via the slip-free torque transmission devices and the overload clutch, with the overload clutch terminating a connection for conjoint rotation of the intermediate shafts when an adjustable torque is exceeded.

9. The drive assembly of claim 8, wherein each torque transmission device includes two synchronizing bevel gears, each of said bevel gears including an input shaft connected to a corresponding one of the intermediate shafts for conjoint rotation, and an output shaft, and further comprising a shaft connection connecting the output of one of the bevel gears with the output shaft of the other one of the bevel gears and configured to allow an offset of the output shafts of the bevel gears.

10. The drive assembly of claim 9, wherein the shaft connection includes an articulated shaft and/or a compensating clutch.

11. The drive assembly of claim 8, wherein each of the torque transmission devices includes a chain or a toothed belt for connecting the intermediate shafts to each other.

12. The drive assembly of claim 8, further comprising gear wheels respectively arranged on the drive shafts and the intermediate shafts and meshing directly with each other.

13. The drive assembly of claim 8, wherein each of the gear transmissions includes at least one drive train spur gear stage and/or drive train bevel gear stage and/or drive train planetary gear stage.

14. A method for synchronizing a roller rotation of a roll crusher with two rollers arranged in parallel and a drive assembly including two drive trains configured to drive the rollers in one-to-one correspondence, each said drive train including a gear transmission which comprises a drive shaft configured for connection to a motor, an output shaft configured for connection to a corresponding one of the rollers, and an intermediate shaft arranged between the drive shaft and the output shaft, said method comprising:
releasing a connection for conjoint rotation between the intermediate shaft of one of the drive trains and the intermediate shaft of the other one of the drive trains;
rotating at least one of the intermediate shafts until a defined angular position of the rollers is achieved; and
restoring the connection for conjoint rotation between the intermediate shafts.
